(19) United States
(12) Patent Application Publication
(10) Pub. No.: US 2021/0089979 A1
(43) Pub. Date: Mar. 25, 2021

(54) ANALYTICS SYSTEM AND METHOD FOR A COMPETITIVE VULNERABILITY AND CUSTOMER AND EMPLOYEE RETENTION

(71) Applicant: cg42 LLC, Isle of Palms, SC (US)

(72) Inventors: Stephen Beck, New York, NY (US); Andres Suster, New York, NY (US)

(21) Appl. No.: 17/028,857

(22) Filed: Sep. 22, 2020

Related U.S. Application Data
(60) Provisional application No. 62/905,003, filed on Sep. 24, 2019.

(51) Int. Cl. G06Q 10/06; G06Q 30/00; G06Q 50/00

(52) U.S. Cl. CPC G06Q 10/0635; G06Q 10/06395; G06Q 50/01; G06Q 10/067; G06Q 30/016; G06Q 10/06393

(57) ABSTRACT

An automated computerized system/method that evaluates risk of attrition of company customers or employees. The system/method receives and processes plural frustrations from individuals, automatically identifies key frustrations, combines and evaluates those key frustrations based on a computerized mathematical model, determines company level vulnerability based on a segmentation of the individual frustrations, and calculates a business value at risk, caused by a probability of attrition of employees or customers. The system/method utilizes binominal logistic regression analysis to translate the calculated individual-level vulnerability score into a probability of attrition of employees or customers and calculates the business value at risk. Companies may then implement remedial measures to prevent company value erosion or capture predicted value shift from competitors.

### REFERENCE TO RELATED APPLICATION

This application claims priority to U.S. Provisional Patent Application No. 62/905,003, filed Sep. 24, 2019, the entire disclosure of which is incorporated herein by reference in its entirety.

### FIELD OF THE INVENTION

The present invention relates to automated and computerized analytics processing in customer and employee retention. More particularly, the present invention relates to an automated computerized system that provides modeling, identification, determination and analysis of various risks of customers leaving a particular service provider along with internal employee retention factors, risks and impact, and after modeling and evaluating of key predictive factors of customer and employee behavior, determining the impact of predicted behavior on the organization.

### BACKGROUND

In recent years, many companies have developed policies and procedures to identify factors relating to competitive edge and client and employee retention. These policies are intended to identify and reduce dissatisfaction with a product or service, and to increase client and employee retention.

The loss of key employees and retraining is time-consuming and utilizes significant resources, including the time and effort needed to train newly hired employees, who typically join a company at different times. As a result, many companies desire to undertake an automated analysis of various risk factors, including human and industry factors, that affect the retention of employees (particularly in the service industry).

Similarly, many companies undertake and conduct surveys to determine customer satisfaction or dissatisfaction with the company's products or services. For the purposes of this application, the terms “employees” and “customers” are used interchangeably, unless expressly specified to the contrary in the immediate description.

### SUMMARY OF THE INVENTION

As will be described, one aspect/function of the automated analysis of the present invention is to identify and have the software perform automatic analysis of key dissatisfaction factors affecting retention of employees and to provide a resulting plan that reduces short-term and long-term employee attrition.

An observation of current systems and methods indicates a need for a deeper understanding of customer behavior, and more importantly the drivers of that behavior, If, for example, currently used survey methodology is applied to assess and quantify customer attrition for a retail bank (e.g., for a given bank project in year 2010), the results would indicate that there is a lack of connection between the survey methodology (known and used in the industry) and the actual results (quantifiable losses of customers and impact).

One of the problems of currently used methodologies and surveys is that most customers overstate satisfaction, and do not use positive emotion to strengthen relationships with companies. In order to counter this, one of the features of the present invention is to identify, quantify and automatically evaluate negative emotions and frustrations of customers. This allows companies to have a better understanding of key driving factors and also to be able to automatically evaluate the more definite drivers of customer behavior, and moreover, to predict customer attrition.

Furthermore, currently used standards for questionnaires utilized for determining customers' and employees' frustrations are designed in an overly simplistic manner. The questions concerning frustrations are typically asked in a binary way (e.g., whether something is perceived positively or negatively). Very little attention is given to the nuances, relationships with other factors or understanding the impact of each frustration or negative experience on the future conduct.

Furthermore, currently utilized methodologies do not use or provide the desired analysis of the impact of frustrations and customer attrition on the competitive dynamics of an industry. In other words, there is very little analysis, automated or other, of determining who has “gained” and who has “lost” from a particular set of frustrations, or from alleviating frustrations of customers or employees. Thus, realizing the existing gap in the current methodology, the present invention provides a more enhanced, comprehensive and automated predictive modeling system of customer and employee behavior, which automatically correlates various factors and components in the overall analysis. It also automatically evaluates the impact on the company and industry at issue.

In order to address and resolve some of the problems of the prior art and the need for a more efficient and enhanced solution, the present invention implement in certain embodiments an automated computerized system, with computer processors executing specific computer instructions, or in other embodiments a method that (1) receives and processes data that includes/pertains to a plurality of frustrations from individual related to the company; (2) automatically identifies the key frustrations from that received data; (3) automatically combines and evaluates key frustrations based on a computerized mathematical model; (4) determines company level vulnerability based on segmentation of individual frustrations of the individuals related to the company; and (5) calculates a business value at risk, caused by a probability of attrition for the segments of individuals.

The calculated business value at risk may be displayed on a display screen, printed (e.g., via a printer) or transmitted through a computer network to the company management, where it then can be utilized by company management to quantify monetary losses caused by the predicted attrition among the individuals related to the company. Company management may further utilize the quantified and calculated Business Value at Risk (monetary losses) to implement a set of remedial measures to be carried out by the company in order to prevent company value erosion or to capture the value shift from one or more competing companies.

The implemented automated system and/or method of the present invention are utilized in certain instances to remedy frustrations and monetary losses due to attrition of company employees, or frustrations and attrition of the company's customers, or both. It can further applied to other persons that use company's products, services or involve company resources.

In certain embodiments, the automated system/method of the present invention evaluates multiple factors, including, without limitation, any set of factors such as (a) a frequency of at least one frustration; (b) a uniqueness of at least one frustration; (c) a determination whether at least one frustration is shared by the individual with others, including coworkers or family members; (d) a determination of an impact of at least one frustration on a relationship with the company; and/or (e) a determination of how much the at least one frustration prompts switching from the company, company product or company service. The system/method then, in certain instances, assigns frustration level scores for different key frustrations, evaluates the key frustrations as part of the mathematical model, and/or calculates an average frustration score for the company (e.g., on a 1-10 scale or other appropriate scale).

Frustrations processed in accordance with the present invention includes, in certain embodiments, industry benchmarking data, qualitative research data, direct customer data, social media compiled data, media or news coverage pertaining to the company or individuals, and data about individuals who recently switched from the company to another company or had switched to another company's products or services.

In certain instances of the present invention, industry benchmarking data includes out-of-category benchmark data that comprises determining the average tenure relationship with the individual associated with the company, the average revenue derived by the company from the relationship with the company, new relationship growth in an associated industry, and trends data.

In accordance with certain embodiments of the present invention, the inventive system/method for processing, modeling and evaluating customer frustrations takes into account at least one value creation factor, such as a combination of the following: (1) deals and financial benefits information of competing companies; (2) data about competing companies with strong customer service; (3) data about product upgrades for different products; (4) information about ease of access to company support; (5) evaluations about knowledge of a company support staff; (6) timeliness of requests and services provided to customers; (7) data about convenience of services for customers; and (8) information about ethical conduct and honesty of the companies and management; and the modeling evaluates and computationally assesses which companies of the plurality of competing companies benefit most from the business risk of others.

The inventive system/method for processing, modeling and evaluating employee frustrations, in certain embodiments, takes into account at least one value creation factor, such as a combination of the following: (1) data about perks and benefits offered to the company employees; (2) data about timeliness of employee requests; (3) data about career progression of the company employees; (4) data about transparency of a feedback to the company employee requests; (5) data about decision empowerment of employees; (5) information about ease of access to answers for the employees; and (6) processing information about ethical conduct and honesty of the companies and management; and (7) data about perceived fairness about the company. The modeling also evaluates and computationally assesses which companies of the plurality of competing companies benefit most from the employee attrition of the others.

The inventive system/method also, in certain instances, accesses, reviews and automatically assesses multiple public social media posts and media coverage posts on the Internet about one or more competing companies, and assigns a positive or negative sentiment to each found post.

The inventive system of automatic identification of key consumer frustrations from the received data involve, in certain instances, evaluating select factors, such as (1) the strength of the company's current relationship with the consumers; (2) the consumer engagement with industry; (3) the consumer satisfaction with the company; (3) the out-of-category expectation setting, including evaluation of an income-based category engagement levels with other products, and which organizations define an industry's role; and (4) the identity of the primary relationship owner, including identification of the primary company or product manufacturer of the consumer product.

The inventive system of automatic identification of the key consumer frustrations from the received data involve, in certain embodiments, evaluating certain factors such as: (1) the strength of the company's current relationship with its employees; (2) the employee engagement with industry; (3) the employee value created for the company; (4) the functional role of the employee within the company; and (5) the employee's responsibility for others.

The inventive modeling and evaluation of the key frustrations from the received frustration data comprises automatically assigning a Vulnerability Score for each individual frustration, for individual customers or employees, for one or more companies, and for the industry overa. The Vulnerability Score may be calculated as a weighted average of the frustration factors, with specific weights assigned to the evaluated frustration factors. It could utilize a binominal logistic regression analysis to translate one or more individual-level Vulnerability Score into a probability of attrition for that individual with respect to company employment, or use of company products or services. The individual probability of attrition results for a plurality of individual can be segmented into groups, based on the determined individual Vulnerability Scores, and the determined Vulnerability Scores for different groups can be utilized to determine a Business Value at Risk for the company, including a calculation of revenue or value shift from the company or overall industry.

Various other features and benefits of the present invention will become readily apparent to those of ordinary skill in the art from the following detailed description of the invention.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 illustrates a general structure, organization and operation of the Competitive Vulnerability overall process, both for consumer and employee applications, in accordance with at least one embodiment of the present invention.

FIG. 2 illustrates sample Vulnerability Score calculations at the individual frustration level and company level, with assigned corresponding weights general for individual component structure, illustrated for a bank case automated evaluation in accordance with at least one embodiment.

FIG. 3 illustrates a binomial logistic regression that may be used for translating the Vulnerability Score, calculated in accordance with at least one embodiment, into the probability of an individual customer attrition or employment switching.

FIG. 4 illustrates an automatically calculated industry analysis output based on the calculated customer attrition analysis for a retail banking industry in accordance with at least one embodiment.

FIG. 5 illustrates an automated individual firm analysis output, based on a Customer Attrition methodology, applied in accordance with at least one embodiment, for a specific bank in the retail banking industry.

FIG. 6 illustrates Competitive Vulnerability financial impacts based on the Customer Attrition output for a cable industry, calculated in accordance with at least one embodiment.

FIG. 7 illustrates a Competitive Vulnerability process for automatically determining the risk value in accordance with at least one embodiment.

FIG. 8 illustrates an overall Competitive Vulnerability automated process in accordance with at least one other embodiment.

### DETAILED DESCRIPTION

The Competitive Vulnerability Modeling and Analysis (henceforth referred to as “the Vulnerability Study” or “Competitive Vulnerability”) was developed and applied in at least one embodiment of the invention as an automated quantitative market research methodology and process. It is automatically evaluated and applied in order to solve the problem of understanding, quantifying, evaluating and predicting the potential losses or gains due to customer frustrations in the retail banking industry.

In other embodiments, the methodology and process of the present invention has been expanded and applied to at least four additional industries. From the specific instances, it also been applied as an internal, employee-centric general Competitive Vulnerability model, to understand the main causes and impacts of employee attrition in any industry in accordance with at least one embodiment.

In at least one embodiment, the automated process identifies, quantifies and evaluates key frustrations and then calculates and predicts the customer behavior based on the evaluated key frustrations. In at least one embodiment, it may utilize uses cases for the increasingly studied employee culture sector of workplace development, expanding the inquiry and analysis well beyond just examining employees' overall satisfaction. The present invention, in at least one embodiment, relates the employee frustration and engagement with customer engagement and attrition. Thus, in at least one embodiment, it creates and evaluates a link between the internal frustrations of the employees and the external competitiveness of an organization. It also applies the analysis to different organizations in the same industry.

In at least one embodiment, the automated system of the present invention executes computer instructions on a computer processor, causing the processor to receive, process and analyze data about typical frustrations that customers and employees have, along with experiences they have been promised, but which may have failed to materialize. The computer program further causes the processor to evaluate the decision-making process at most organizations and automatically determines the best way to quantify the impact of the frustrations financially, either for a particular company, industry, or both.

Another feature of the present invention, in at least one embodiment, is the use of an automated computerized system to understand and evaluate the main drivers of change in business—both inside companies and within competitive industries. In one or more embodiments, the computer process executes computer instructions that cause the processor to automatically examine and evaluate at least one survey and other data sources. It then calculates and determines and quantifies the ‘at risk’ value in a given industry, as well as the key drivers of (or main components that influence) such risk.

In at least one embodiment, the automated system of the present invention executes computer instructions on a computer processor, causing the processor to automatically identify, process, quantify and evaluate the frustrations with a given organization by the customers that utilize the organization for some services within a competitive industry. In other embodiments, the processor executes another set of computer instructions to automatically identify, process, quantify and evaluate the frustrations with a given organization experienced by the employees within the company.

In at least one embodiment, the present invention executes computer instructions that cause the processor to automatically capture and evaluate the impact of negative experiences on customer and employee behavior. Because frustration and negativity has been documented extensively to drive action, especially when compared to positive experiences, the present system, in accordance with some embodiments, utilizes the identified and quantified frustrations to provide output and results that help the company management in quantifying, anticipating, and developing strategies to stem customer and employee attrition from a company.

From a competitive perspective, the analysis and output provided in accordance with at least one embodiment, allows the analyzed service provider company to quantify and predict the customers that are “at risk” of leaving the service provider, those who are projected to actually switch or cancel services, and the beneficiaries of such customer attrition in a given industry. From an internal employee perspective, the analysis and results provided in accordance with at least one embodiment help the management isolate employee frustrations and project employee attrition, drivers of such attrition, and competitors who might gain skilled workers (i.e., the beneficiaries of the skilled employee attrition). In at least one embodiment, the computerized system of the present invention performs automated analyses that include a financial component, modeling the short- and long-term financial impacts of Competitive Vulnerability and attrition on the company and industry.

One of the features of the Vulnerability Study in one or more embodiments is to and model the impacts of negative experiences on both consumer and employee behavior and predict impacts of certain frustrations on companies and industries. The Vulnerability Study method may also act as both a diagnostic tool and a roadmap for change in an industry—whether driven by competitive consumer or employee dynamics.

The Vulnerability Study in one or more embodiments may also evaluate the impact of frustrations on the firm's overall value. In consumer applications, this means examining the value of individual consumers and profiling those consumers' relationships with given companies. Based on the analysis, the Vulnerability Study analysis may determine, in one or more embodiments, the predicted share of consumers that are “vulnerable,” based on their level of frustration related to the category mean, and the predicted share of consumers that are likely to end their relationship with (i.e., stop using a particular service) a given service provider. It may also automatically determine the value that the frustrations/vulnerability represents to a company based on an average value per consumer, where the latter is available either via a survey or from the company's financial disclosures.

In connection with employee retention, the Vulnerability Study, in accordance with at least one embodiment may examine the top frustrations for individual employees, quantify and determine the level to which those frustrations impact the at-will employment, and then automatically calculate and predict the share of “vulnerable” employees who will leave, or likely to leave, a particular company in a given year. An extra analysis may also be conducted to automatically calculate, determine and model the impact of the employee attrition on customer value, both in terms of satisfaction and the financial value per customer.

The Vulnerability Study's treatment of consumers and employees, in accordance with one or more embodiments, gauges the longitudinal frustration levels by performing the analysis in accordance with at least one embodiment at least every other year, and thus capturing trends in a company's ability to deliver on customer or employee satisfaction. It may also evaluate, determine, analyze and provide summary output for the areas where the company outperforms, or where it underperforms, or where it is on par with others in the category (or industry-wide) frustrations.

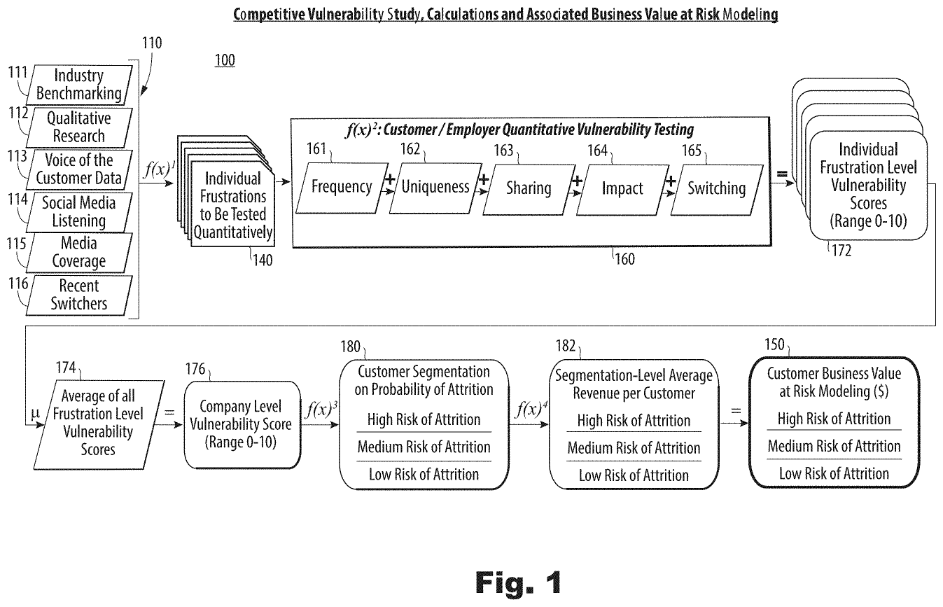

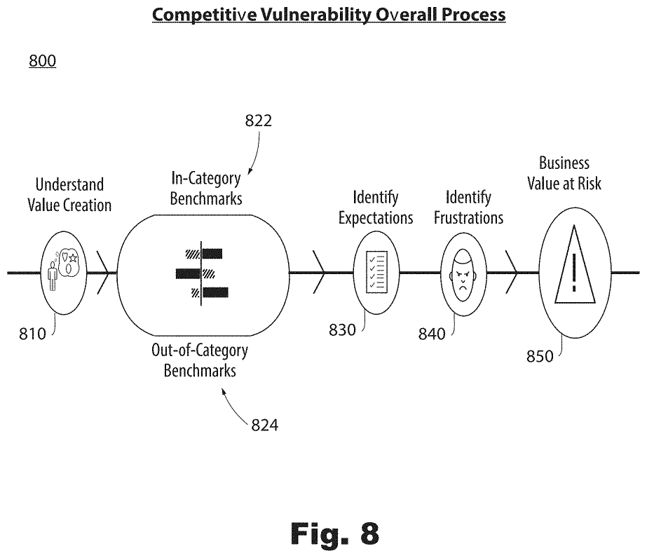

Referring to FIGS. 1 and 8 of the accompanying drawings, the Competitive Vulnerability method or system utilizes a computer processor execute computer instructions that cause the processor to process a number of data sources and further perform various steps and functions described below with reference to FIGS. 1 and 8. The system and method performs automated calculations and processing to determine the Associated Customer Business Value at Risk Modeling 150 by performing the steps of the system and method 100 in FIG. 1 and incorporating multiple phases and factors in accordance with at least one embodiment. The calculated Business Value at Risk may be displayed on a computer display screen of a computer device, or transmitted through a network to the company management and utilized to reduce the calculated cost of attrition to the company.

The exemplary embodiment shown in FIGS, 1 and 8 uses a number of input data sources as individual frustrations that are quantified and analyzed by the computer system. The system processes individual (1) frustrations, 110 and 810, in order to understand and apply the correct measure of Value Creation and Value Degradation. After receiving multiple individual frustrations, the system (2) identifies the Key Frustrations that are to be tested quantitatively, 140 and 840.

After identification of the key frustrations, the system (3) surveys and automatically models the identified key frustrations 160 using a computerized mathematical model. The computerized and automated model utilizes, quantifies and evaluates such factors as frequency of a particular frustration, 161, uniqueness of the specific frustration, 162, whether the frustration is shared 163, the impact of the frustration, 164 and whether the customer or employee is likely to switch to another company or service, or has done so in the past, 165. The details of the automated modeling in accordance with at least one embodiment are described further below. In one or more embodiments, the computerized system may calculate an Individual Frustration Level score for a particular frustration or a set of frustrations. In one of more embodiments, it may assign a score of 1-10 to the Individual Frustration Level as frustration level value.

Following the quantization of the frustration level scores for various different frustrations 172, the computerized system then can determine an average frustration score, 174. The average frustration score can also be calculated on a 1-10 scale, for a set of related and evaluated frustrations for a particular company or provided by a particular individual.

The average frustration score can then be utilized to determine and (4) assess company-level vulnerability, 176 by segmenting customers on probability of attrition 180. The company vulnerability score can also be on a 1-10 scale, while probability of attrition may be used the determined vulnerability scores to determine the segments (employees or customers) that have a high, medium or low risk of attrition. For customers, the system may also determine a segment-level average revenue per customer, for each segment that has a high, medium or low risk of attrition, as indicated in 182.

In at least one embodiment, the computerized system uses the calculated probabilities of attrition for customer segments analysis, and calculated revenue averages for each segment to (5) automatically determining Business Value at Risk 150 and 850 in FIGS. 1 and 8, respectively. It may also include a process step of identifying key expectations 830 and industry benchmarking 111 and 811, which may include in-category benchmarks 822 and out-of-category benchmarks 824.

(1) Frustration Data for Understanding Value Creation and Degradation

Referring to FIG. 1, the process step of obtaining various types of data related to frustrations, 110 (used for understanding value creation and value degradation in accordance with at least one embodiment) may utilize such data points as industry benchmarking 111, qualitative research 112, voice of the customer data 113, social media listening 114, a review of media/news coverage 115, and an in-depth analysis into customers or employees who have recently switched 116 to understand areas of value creation and value degradation across an industry's players. In at least one embodiment it may be applied to customers, while in other embodiments it may be applied to employees. In some embodiments, it may be applied to both, the customers and employees for a particular business or industry.

Industry Benchmarking

Industry Benchmarking, 111 and 811, may include automatically processing (by a computer processor executing computer instructions stored in computer memory) the private and publicly available data on companies to determine current and historical movements in market share, customer expectation, and satisfaction metrics, as well as, or in addition to, the ARPU (average revenue per unit) and employee turnover. The out-of-category benchmarks 824 for identified areas of value creation may also be examined and evaluated. The following aspects of an industry are considered as part of the benchmarking exercise: (1) Average customer/employee relationship tenure; (2) Average customer/relationship revenue; (3) New customer/employee growth in industry; (4) Trends in the above over time (where available).

Qualitative Research

Qualitative Research, 112 may include interviewing stakeholders to determine category-specific value creating activities, and which corresponding activities would erode value or cause frustration. The data collected is then electronically processed and evaluated by a computerized system in at least one embodiment of present invention.

In at least one embodiment, the sample areas of value creation for consumers may be the following: (1) Deals and financial benefits; (2) Strong customer service; (3) Product upgrades; (4) Ease of access; (5) Knowledge of staff; (6) Timeliness of requests/service; (7) Convenience of service; (8) Ethical/honesty of the company. These value-creation factors may be utilized in the evaluation process and calculations to computationally assess which companies would benefit most from the business risk of others.

In another embodiment, the areas of value creation for employees may include the following factors: (1) Perks/benefits; (2) Timeliness of requests; (3) Career progression; (4) Transparency into feedback; (5) Decision empowerment; (6) Ease of access to answers/knowledge; (7) Ethical/honesty of the company; and (8) Perceived fairness.

Voice of the Customer Data

The Voice of the Customer Data, 113, may also be utilized and processed in at least one embodiment, particularly when such data is available from clients to leverage their existing customer or employee feedback to assess areas of value creation and value degradation. The data is collected from proprietary sources within the organization such as CRM systems and is electronically processed and evaluated by a computerized system of the present invention.

Social Media Listening and Media Coverage

The Social Media Listening 114 may include an additional computer-automated process, where at least one computer processor executes specific computer instructions stored in computer memory, and causes the processor to access, review and automatically assess public social media posts on the internet about the company and/or company's customer relations or employment practices. It may access bulletin board where employees or customers share their experiences or provide reviews and/or comments about companies, company products or services. Similarly, the Media Coverage 115 may involve the access, review and automatic assessment of various media coverage on companies being analyzed by the present system.

The at least one embodiment may further utilize an artificial intelligence software, including the specific software executed by a processor that causes the processor make different decisions and change the specific approach depending on the received results, to categorize and assign a sentiment (positive or negative) to each post/mention in the social media. The AI (or software) may then aggregates the assigned sentiments in order to provide a detailed picture of the key areas of value creation and frustration associated with each of the companies being analyzed, as well as the respective industries.

Recent Switchers

The Recent Switchers 116 analysis is an automated and computerized quantitative analysis performed by the computer processor that executes specific computer instructions that cause the processor to determine and process the reasons why customers or employees of a particular company have recently switched. The software system may also create benchmarks and uncover the key reasons that have driven actual switching by customers or the employee attrition behavior in the past. For example, it could determine which employees asked for a raise or bonus and switched to another company when they did not get the expected or favorable response.

(2) Identifying Key Frustrations to be Tested

Referring to FIGS. 1 and 8, the identification of key frustrations 140 or 840 (that are tested and evaluated in one or more embodiments) may utilize a computerized process for automatically analyzing customer pain points and determine/identify the key or most important individual frustrations to test in research by leveraging industry benchmarking, primary qualitative research, client internal voice of the customer data, social media posts, media coverage of industry and specific companies being analyzed. This approach helps create an in-depth analysis into the reasons why recent customers/employees have switched based at least in part on industry benchmarks and comparison of those benchmarks with the actual data.

In at least one embodiment, the present invention calculates and determines (using at least one computer that executes computer instructions stored in memory) what factors and constrains define the customer's or employee's expectation in a given industry, and/or expectations with a given company. Factors are extracted (i.e., derived) using a principal component analysis and are then rotated to improve interpretability using an automated statistical software.

In one embodiment involving consumers, the following constrains and factors are automatically calculated and utilized by at least one processor in this phase:

(1) the strength of the current relationship (i.e. how many products are ordered from a company, how long has that relationship been going on);

(2) the engagement with industry (i.e. how many firms or companies are products owned from, what is the perceived role of the company in this person's life);

(3) the satisfaction with company (i.e. net promoter score, satisfaction level, self-reported loyalty rank).

(4) the out-of-category expectation setting (i.e. income-based category engagement levels with other products, which organizations define an industry's role), and

(5) the identity of the primary relationship owner which is this consumer's primary company or product manufacturer).

In another embodiment involving company employees, the following factors and constraints are automatically evaluated by a computer processor to determine and calculate:

(1) the strength of current relationship (i.e. employee tenure at company, self-reported level of engagement);

(2) the engagement with industry (i.e. employee tenure in industry);

(3) the employee value created for the company (i.e. number of customer relationships, organizational positioning);

(4) the functional roles (i.e. level of seniority, area of organization); and

(5) the responsibility for others (i.e. direct reports, indirect relationships).

(3) Surveying and Modeling Frustrations

The process step of Surveying and Modeling Frustrations 160 may involve testing, by executing computer instructions by a processer, the frustration factors with consumers, along with value of current relationship and behaviors related to switching and cancellation decisions. This is also replicated for internal applications related to employees quitting their given employer.

The process of testing via automated, computerized market research with customers or employees of the companies being analyzed. The customer or employee frustrations and levels of frustrations may be tested for and account for various characteristics, including without limitation the following: (a) Frequency 161, indicating how frequent this frustration occurs; (b) Uniqueness162, indicating how unique the frustration is to a given provider or employer; (c) Sharing 163, indicating how often the frustration is shared with friends or family; (d) Impact 164, indicating how much the frustration impacts the depth of the relationship with a provider or employer; and (d) Switching 165, indicating how much the frustration prompts switching away from this provider/employer.

An example of some of the key metrics that may be tested in the survey and modeling of frustrations are illustrated in 160 in FIG. 1. Ultimately, the illustrated frustrations factors may be used by the processor to determine and create a vulnerability “score” for each individual frustration 172, for individual customers or employees overall 174, for companies 176, and for industries.

Analysis can be completed on each individual frustration metric, but those metrics may be weighted and combined to create a score for each respondent, and thus provide an average score for each company in the analysis. In at least one embodiment, the present invention may utilize the weighted scheme of automatically calculated values and elements by at least one computer processor (executing specific computer instructions), to arrive at the most valid or best suited industry-specific solution.

Therefore, in at least one embodiment, the vulnerability score may be a weighted average of the frequency with which each frustration is experienced (0 to 100 scale), the perceived uniqueness of each frustration (0 to 100 scale), the frequency with which customers/employees voice/share that frustration with colleagues, friends, or on social media (0 to 100 scale), the impact each frustration has on customers'/employees' likelihood to deepen or commit more to that relationship (0 to 100 scale), and the impact that frustration has on switching (0 to 100 scale).

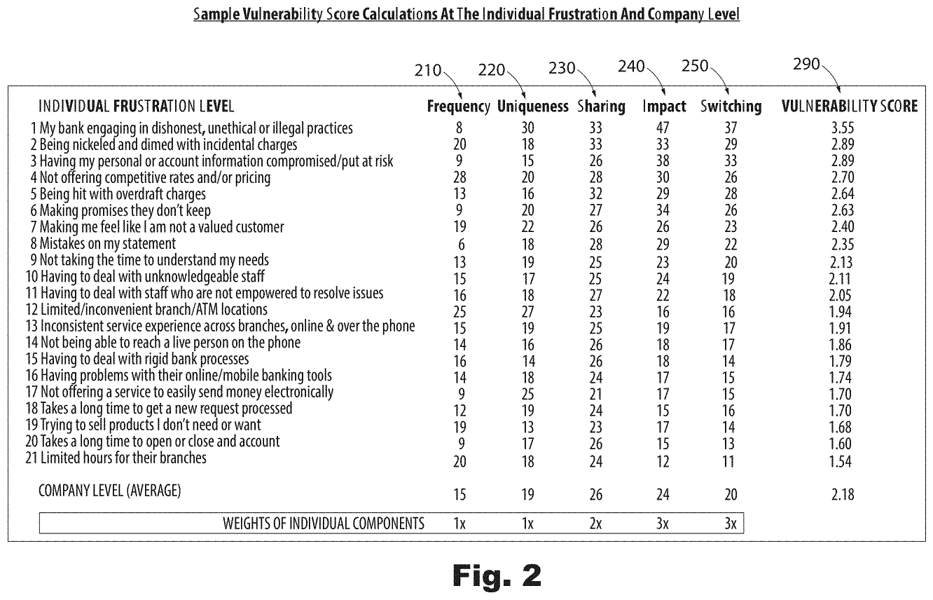

In at least one embodiment, sample weights and calculations of individual frustrations can be calculated as illustrated in FIG 2, which illustrates the Sample Vulnerability Score Calculations at the Individual Frustration and Company Level with Corresponding Weights. In at least one embodiment, the Vulnerability Scores are calculated to range from 0 to 10, with 0 signifying a frustration does not occur at all and has no impact on perceptions of uniqueness, or on actual behaviors around sharing, deepening and switching. A score of 10 signifies that a frustration occurs frequently and has significant impact on perceptions of uniqueness and on actual behaviors around sharing, relationship deepening and switching.

In the example on FIG. 2, the weights that may be used for each frustration metric are: Frequency 210=1, Uniqueness 220=1. Sharing 230=2, Impact 240=3, and Switching 250=3. Weights by definition for all components should add up to 10. The method used to arrive at the specific weights is automated and involves execution of a regression analysis and accounts for wider industry trends in helping to automatically predict switching behavior.

(4) Assessing Company-Level Vulnerability by Segmenting Customers on Probability of Attrition

The process step of Assessing Company-Level Vulnerability by Segmenting Customers on Probability of Attrition 180 is done after the frustrations have been tested and vulnerability scores are calculated for each individual frustration. The results are automatically modeled to determine:
The frustration level (i.e., vulnerability score) for each individual customer/employee
The frustration level (i.e., vulnerability score) for each individual firm
The overall frustration level (i.e., vulnerability score) with the industry

The output of this modeling is a vulnerability ‘score’ 290, compiled from the above metrics relating to individual frustrations. This score can be applied and evaluated horizontally—i.e. what is the most intense frustration—and vertically—i.e. which firm or company is the most vulnerable. This is further accentuated by determining and predicting which consumers or employees will definitely leave their provider or employer in the next 12 months.

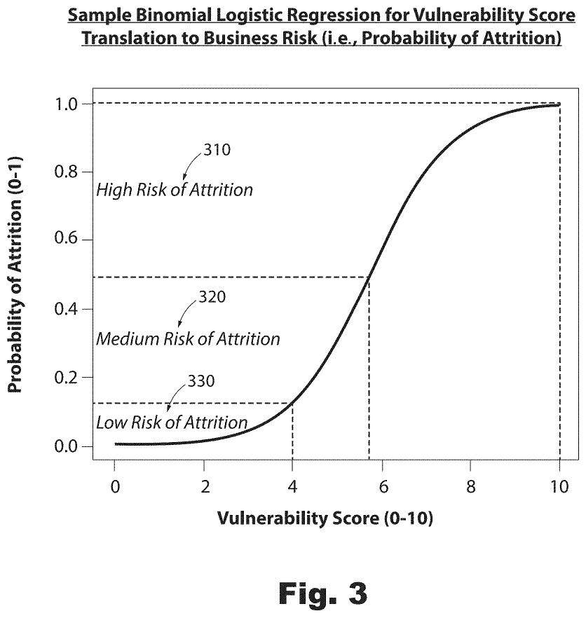

An automated, statistical computation processing may utilize binomial logistic regression analysis, to translate customer-level vulnerability scores into an individual customer's probability/likelihood to attrite, as illustrated in FIG. 3, entitled Sample Binomial Logistic Regression for Vulnerability Score Translation to Business Risk (i.e., Probability of Attrition).

Individual results are utilized to segment a company's customer/employee population into three groups based on likelihood to attrite:
High Risk of Attrition 310: highly frustrated group that is considered to be “high risk” of switching/cancelling. These customers have also likely indicated they will be leaving their provider/employer in the next 12 months.
Medium Risk of Attrition 320: frustrated group that is considered to be “medium risk” of leaving their current provider/employer. These customer/employees may have also indicated they have considered leaving their current provider/employer in the last 12 months and are still considering action.
Low Risk of Attrition 330: group of customers that are happy on at “low risk” of leaving their current provider as informed by their overall vulnerability scores.

(5) Automatically Determining Business Value at Risk

The step of Automatically Determining Business Value at Risk 50 and 850, as illustrated in FIGS. 1 and 8, may be based on and include calculations of a company, industry, and individual respondent financial data, as well as share of vulnerable populated projected to switch providers/employers. The model for the business-value-at-risk of being lost could be developed for either the individual companies or industry overall. For the employer-focused study, the present invention may determine and provide a connection between employee attrition and customer value lost.

In at least one embodiment, based on the self-reported value created for the business, two of the three previously identified segments (High Risk of Attrition 310 and Medium Risk of Attrition 320) may be utilized and evaluated as the financial value risk for an individual company or provider. This step may also determine and calculate the total amount of revenue or value shifting amongst players in an industry. In other words, it may quantify and evaluate whether a particular financial value shift is “up for grabs” for the other competitors (at the expense of the losing entity).

This phase of the methodology can also act as a diagnostic tool for individual companies, to determine a strategy for either capturing new value or preventing value erosion by addressing the key identified and quantified frustrations causing attrition. The predictive analysis and remedial measures may come from either the firm itself or from major competitors projected to lose the most value in a particular industry.

In at least one embodiment, the Vulnerability Study's final output is a rank list of frustrations across the industry and company, a comparative ranking of most vulnerable firms, projected attrition, business value at risk for firms, and potential capturers of that value being lost by most vulnerable firms.

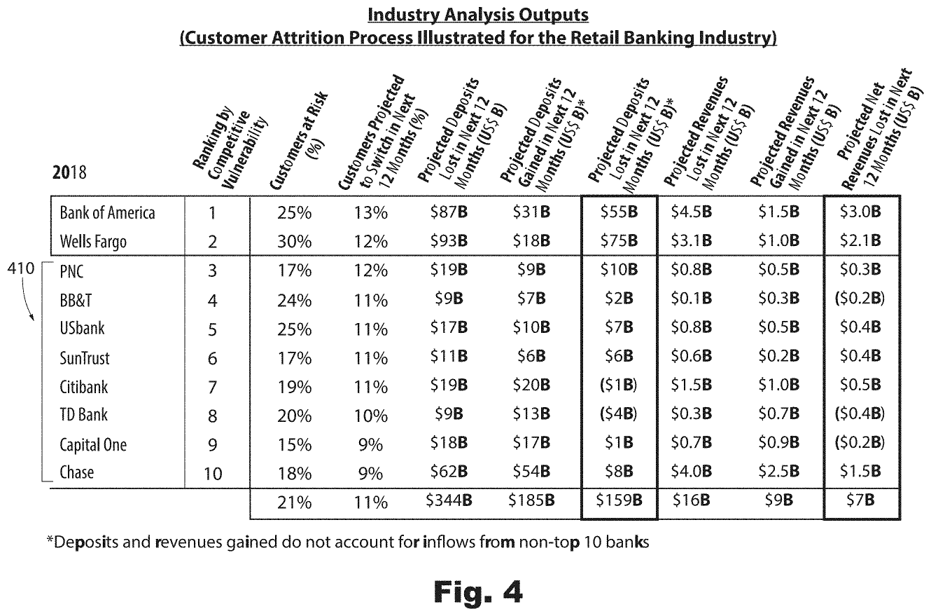

FIG. 4 illustrates Industry Analysis Output based on the Customer Attrition process applied in accordance with at least one embodiment for the retail banking industry. The table in FIG. 4 illustrates the industry-level output for several retail banks 410. It shows ranking of each bank in the retail banking industry, projected losses (financial and in the customer base), projected gains based on switching indicators, and banking-specific revenue to the deposit factors.

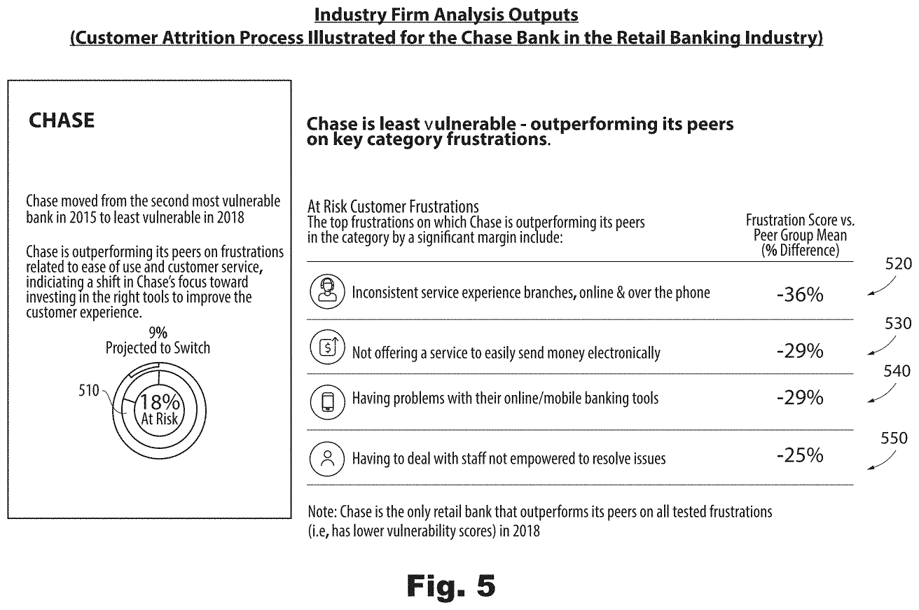

FIG. 5 illustrates the Individual Firm Analysis Output based on the Customer Attrition process for a specific bank (e.g., Chase bank) in the retail banking industry. It shows the calculated “at risk frustrations” 510 and particularly the Frustration Score (calculated in accordance with at least one embodiment) versus the peer group mean value. As indicated, the highest frustration score is attributed to the frustration factor of having inconsistent experience across branches, offline and over the phone (−36%) 520. The next frustration involves not offering a service to allow automatic and simple money transfers (−29%) 530, followed by having problems with the online or mobile banking tools (−29%) 540. The last frustration illustrated in FIG. 5 involves having to deal with staff that is not empowered to resolve a particular issue or frustration (−25%) 550.

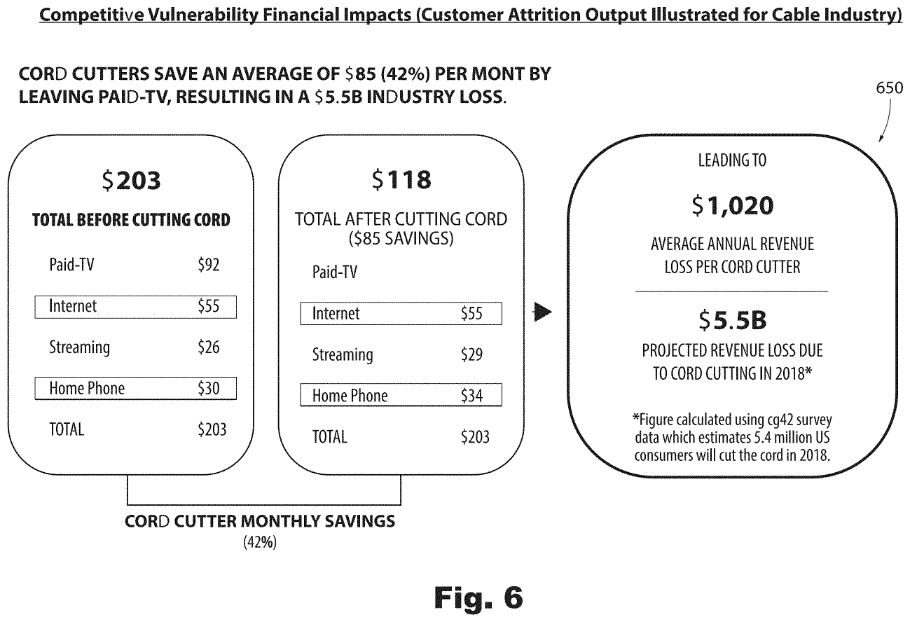

FIG. 6 illustrates the Competitive Vulnerability Financial Impacts, and customer attrition output for the cable industry. It indicates the financial impact for the customers in the cable industry, both in terms of savings for individual customers and industry-wide impacts. It also shows a loss 650 of $5.5 B to the industry due to customers' frustrations and dropping their cable services as a result of their frustrations.

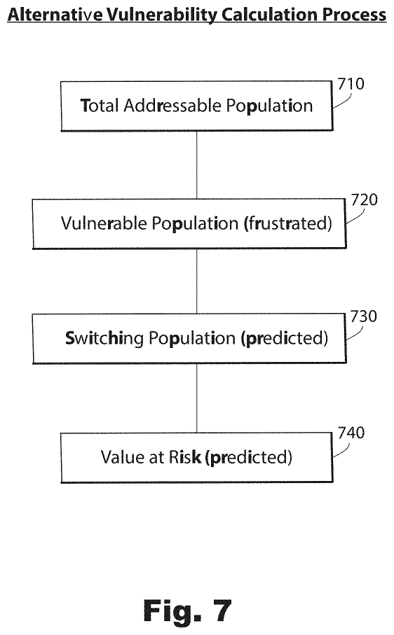

FIG. 7 illustrates an alternative Competitive Vulnerability process in accordance with at least one embodiment. This diagram indicates how the total population 710 is cut down to determine the Vulnerable population 720, is the portion that is frustrated 720. From it, the system and method determines the Switching subpopulation 730. From the Switching subpopulation 730, the Value at Risk 740 is calculated. The Value at Risk 740 calculation may include predicting the actual losses of customers or employees by a company or an overall industry in accordance with at least one embodiment. The Value at Risk 740 may also include quantified financial losses to the company or losses in value shift of employees or customers to a competitor. It also indicate the overall quantified predicted losses for the overall industry.

It will be understood by those skilled in the art that each of the above steps or elements of the system will comprise computer-implemented aspects, performed by one or more of the computer components described herein. For example, any or all of the steps of collection, evaluation, processing and modeling of the frustration factors and data may be performed electronically. In at least one exemplary embodiment, all steps may be performed electronically—either by general or special purpose processors implemented in one or more computer systems such as those described herein.

It will be further understood and appreciated by one of ordinary skill in the art that the specific embodiments and examples of the present disclosure are presented for illustrative purposes only, and are not intended to limit the scope of the disclosure in any way.

Accordingly, it will be understood that various embodiments of the present system described herein are generally implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, the inventions are described in the general context of computer-executable instructions, such as program modules or engines, as described earlier, being executed by computers in networked environments. Such program modules are often reflected and illustrated by flow charts, sequence diagrams, exemplary displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

Calculations and evaluations described herein, and equivalents, are, in an embodiment, performed entirely electronically. Other components and combinations of components may also be used to support processing data or other calculations described herein as will be evident to one of skill in the art. A computer server may facilitate communication of data from a storage device to and from processor(s), and communications to computers. The processor may optionally include or communicate with local or networked computer storage which may be used to store temporary or other information. The applicable software can be installed locally on a computer, processor and/or centrally supported (processed on the server) for facilitating calculations and applications.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernible from the description herein, by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention.

It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope.

Accordingly, the scope of the present inventions is defined by the appended claims rather than the foregoing description and the exemplary embodiments described therein.

While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the disclosure.

What is claimed is:

1. An automated computerized system for evaluating attrition risk for a company, comprising:
at least one processor executing a plurality of computer instructions stored in memory, causing the processor to perform:
(1) receiving and processing a data comprising a plurality of frustrations from individuals related to the company;
(2) automatically identifying the key frustrations from the received data;
(3) automatically combining and evaluating the key frustrations based on a computerized mathematical model;
(4) determining company level vulnerability based on segmentation of individual frustrations of the individuals related to the company; and
(5) calculating a business value at risk, caused by a probability of attrition for the segments of individuals,
wherein the calculated business value at risk is utilized by a company management to quantify monetary losses caused by the predicted attrition among the individuals related to the company.

2. The system of claim 1, wherein the individuals related to the company are company employees and the frustration data pertains to the frustrations of the company employees.

3. The system of claim 1, wherein the individuals related to the company are company customers and the frustration data pertains to the frustrations of the company customers to the company services or products.

4. The system of claim 1, wherein the computerized and automated model, created and evaluated by the computer software, utilizes, quantifies, models and evaluates a plurality of factors comprising:
(a) a frequency of at least one frustration;
(b) a uniqueness of at least one frustration;
(c) a determination whether at least one frustration is shared by the individual with others, including coworkers or family members;
(d) a determination of an impact of at least one frustration on a relationship with the company; and
(e) a determination how much the at least one frustration prompts switching from the company, company product or company service.

5. The system of claim 1, wherein the computerized mathematical model quantifies and assigns a frustration level scores for different key frustrations, evaluates the key frustrations as part of the mathematical model, and calculates an average frustration score for the company.

6. The system of claim 5, wherein the frustration level scores and the average frustration score are assigned values in a range from 1 to 10.

7. The system of claim 1, wherein the received data comprising a plurality of frustrations from individuals comprises an industry benchmarking data, a qualitative research data, a direct customer data, a social media compiled data, a media or news coverage pertaining to the company or individuals, and a data about individuals who have recently switched from the company to another company or switched to another company's products or services.

8. The system of claim 7, wherein the industry benchmarking data includes an out-of-category benchmark data, comprising: determination of an average tenure relationship with the individual associated with the company, an average revenue derived by the company form the relationship with the company, a new relationship growth in an associated industry, and a trends data.

9. The system of claim 3, wherein the modeling further takes into account at least one value creation factor for a plurality of different competing companies, which comprises processing:
(1) deals and financial benefits information of competing companies;
(2) data about competing companies with strong customer service;
(3) data about product upgrades for different products;
(4) information about ease of access to company support;
(5) evaluations about knowledge of a company support staff,
(6) timeliness of requests and services provided to customers;
(7) data about convenience of services for customers; and
(8) information about ethical conduct and honesty of the companies and management;
wherein the modeling also evaluates and computationally assesses which companies of the said plurality of competing companies benefit most from the business risk of others.

10. The system of claim 2, wherein the modeling further takes into account at least one value creation factor for the employees of at least one company in the plurality of competing companies, which comprises processing:
(1) data about perks and benefits offered to the company employees;
(2) data about timeliness of employee requests;
(3) data about career progression of the company employees;
(4) data about transparency of a feedback to the company employee requests;
(5) data about decision empowerment of employees;
(6) information about ease of access to answers for the employees; and
(7) processing information about ethical conduct and honesty of the companies and management; and
(8) data about perceived fairness about the company.
wherein the modeling also evaluates and computationally assesses which companies of the said plurality of competing companies benefit most from the employee attrition of the others.

11. The system of claim 1, further including at least one additional computer processor that executes a computer program stored in computer memory, which cause the processor to access, review and automatically assess a plurality of public social media posts and media coverage posts on the Internet about one or more competing companies.

12. The system of claim 11, wherein the computer software assigns a positive or negative sentiment value to each of the plurality of public social media posts and media coverage posts.

13. The system of claim 3, wherein the automatic identification of the key consumer frustrations from the received data comprises evaluating:
(1) the strength of the company's current relationship with the consumers;
(2) the consumer engagement with industry;
(3) the consumer satisfaction with the company;
(4) the out-of-category expectation setting, including evaluation of an income-based category engagement levels with other products, and which organizations define an industry's role; and
(5) the identity of the primary relationship owner, including identification of the primary company or product manufacturer of the consumer product.

14. The system of claim 2, wherein the automatic identification of the key employee frustrations from the received data comprises evaluating:
(1) the strength of the company's current relationship with its employees;
(2) the employee engagement with industry;
(3) the employee value created for the company;
(4) the functional role of the employee within the company; and
(5) the employee's responsibility for others.

15. The system of claim 1, wherein the modeling and evaluation of the key frustrations from the received frustration data comprises automatically assigning a Vulnerability Score for each individual frustration, for individual customers or employees, for one or more company and for an overall industry.

16. The system of claim 4, wherein the Vulnerability Score is a weighted average of the frustration factors, with specific weights assigned to the evaluated frustration factors.

17. The system of claim 16, wherein a sum of all weights for the frustration factors adds up to 10.

18. The system of claim 1, utilizing a binominal logistic regression analysis for translate one or more individual-level Vulnerability Score into a probability of attrition for that individual with respect to company employment, or use of company products or services.

19. The system of claim 18, wherein the individual probability of attrition results for a plurality of individual is segmented into groups, based on the determined individual Vulnerability Scores.

20. The system of claim 18, wherein the determined Vulnerability Scores for different groups is used to determine a Business Value at Risk for the company, including a calculation of revenue or value shift from the company or overall industry.

21. The system of claim 20, wherein the determined Business Value at Risk is used for implementing a set of remedial measures by the company in order to prevent the company value erosion or to capture the value shift from one or more competing companies.

22. An automated computerized method comprising:
(1) receiving and processing by a computer processor, executing computer instructions, a data comprising a plurality of frustrations from individuals related to a company;
(2) automatically identifying a set of key frustrations from the received data;
(3) automatically combining and evaluating the key frustrations based on a computerized mathematical model;
(4) determining company level vulnerability based on a segmentation of individual frustrations; and
(5) calculating a business value at risk for the company caused by a probability of attrition for the segments of individuals,
wherein the calculated business value at risk is utilized by a company management to quantify monetary losses caused by the calculated probable attrition among the individuals related to the company.

23. The method of claim 22, wherein the method receives and processes data pertaining to the frustrations of company employees, and wherein the individuals related to the company are company employees.

24. The method of claim 22, wherein the method receives and processes data pertaining to the frustrations of company customers related to company services or products, and wherein the individuals related to the company are customers that use company products or services.

25. The method of claim 22, wherein the automated evaluation of the key frustrations is performed by the computer software that utilizes, quantifies, models and evaluates a plurality of factors comprising:
(a) a frequency of at least one frustration;
(b) a uniqueness of at least one frustration;
(c) a determination whether at least one frustration is shared by the individual with others, including coworkers or family members;
(d) a determination of an impact of at least one frustration on a relationship with the company; and
(e) a determination how much the at least one frustration prompts switching from the company, company product or company service.

26. The method of claim 22, further quantifying and assigning a frustration level scores for different key frustrations, evaluating the key frustration as part of the mathematical model, and calculating an average frustration score for the company.

27. The method of claim 26, wherein the assigning frustration level scores and the average frustration involves assigning values in a range from 1 to 10.

28. The method of claim 22, wherein the receiving data comprises receiving a plurality of frustrations from individuals comprises an industry benchmarking data, a qualitative research data, a direct customer data, a social media compiled data, a media or news coverage pertaining to the company or individuals, and a data about individuals who have recently switched from the company to another company or to another company's products or services.

29. The method of claim 28, wherein processing of the industry benchmarking data includes processing an out-of-category benchmark data, comprising determination of: an average tenure relationship with the individual associated with the company, an average revenue derived by the company form the relationship with the company, a new relationship growth in an associated industry, and a trends data.

30. The method of claim 24, wherein the modeling further takes into account at least one value creation factor for a plurality of different competing companies, and comprises processing
(1) deals and financial benefits information of competing companies;
(2) data about competing companies with strong customer service;
(3) data about product upgrades for different products;
(4) information about ease of access to company support;
(5) evaluations about knowledge of a company support staff;
(6) timeliness of requests and services provided to customers;
(7) data about convenience of services for customers; and
(8) information about ethical conduct and honesty of the companies and management;
and further evaluating and computationally assessing which companies of the said plurality of competing companies benefit most from the business risk of others.

31. The method of claim 23, wherein the modeling further takes into account at least one value creation factor for the employees of at least one company in the plurality of competing companies, and comprises processing:
(1) data about perks and benefits offered to the company employees;
(2) data about timeliness of employee requests;
(3) data about career progression of the company employees;
(4) data about transparency of a feedback to the company employee requests;
(5) data about decision empowerment of employees;
(6) information about ease of access to answers for the employees; and
(7) processing information about ethical conduct and honesty of the companies and management; and
(8) data about perceived fairness about the company.
and further evaluating and computationally assessing which companies of the said plurality of competing companies benefit most from the employee attrition of the others.

32. The method of claim 22, further including reviewing and automatically assessing a plurality of public social media posts and media coverage posts on the Internet about one or more competing companies.

33. The method of claim 32, further assigning a positive or a negative sentiment value to each of the plurality of public social media posts and media coverage posts.

34. The method of claim 24, wherein the automatic identification of the key consumer frustrations from the received data comprises evaluating:
(1) the strength of the company's current relationship with the consumers;
(2) the consumer engagement with industry;
(3) the consumer satisfaction with the company;
(4) the out-of-category expectation setting, including evaluation of an income-based category engagement levels with other products, and which organizations define an industry's role; and
(5) the identity of the primary relationship owner, including identification of the primary company or product manufacturer of the consumer product.

35. The method of claim 23, wherein the automatic identification of the key employee frustrations from the received data comprises evaluating:
(1) the strength of the company's current relationship with its employees;
(2) the employee engagement with industry;
(3) the employee value created for the company;
(4) the functional role of the employee within the company; and
(5) the employee's responsibility for others.

36. The method of claim 22, wherein the modeling and evaluation of the key frustrations from the received frustration data comprises automatically assigning a Vulnerability Score for each individual frustration, for individual customers or employees, for one or more company and for an overall industry.

37. The method of claim 36. wherein the assigning of the Vulnerability Score includes a weighted average of the frustration factors, with specific weights assigned to the evaluated frustration factors.

38. The method of claim 37, wherein a sum of all weights for the frustration factors adds up to 10.

39. The method of claim 22, further comprising utilizing a binominal logistic regression analysis for translate one or more individual-level Vulnerability Score into a probability of attrition for that individual with respect to company employment, or use of company products or services.

40. The method of claim 39, further comprising segmenting the individual probability of attrition results for a plurality of individual into groups, based on the determined individual Vulnerability Scores.

41. The method of claim 40, further comprising utilizing the determined Vulnerability Scores for different groups to determine a Business Value at Risk for the company, and calculating a revenue or a value shift from the company or an overall industry.

42. The method of claim 41, further comprising:
implementing a set of remedial measures by the company, based on the determined Business Value at Risk;
preventing the company value erosion; and
capture the value shift from one or more competing companies.
